(19) United States
(12) Patent Application Publication
(10) Pub. No.: US 2004/0055772 A1
(43) Pub. Date: Mar. 25, 2004

(54) EMI-suppressing cable

(76) Inventors: Takaki Tsutsui, Tokyo (JP); Tomonori Nakata, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/648,381

(22) Filed: Aug. 27, 2003

(30) Foreign Application Priority Data
Sep. 20, 2002 (JP) P2002-275144

(51) Int. Cl. H01B 7/29

(52) U.S. Cl. 174/36

(57) ABSTRACT

An EMI-suppressing cable includes a signal wire, a shielding layer formed on an outer surface of the signal wire, and a magnetic material layer formed on an outer surface of the shielding layer, and having a ferrite resin layer and a film. The ferrite resin layer is formed on one face of the film so as to form a two-layer structure. The magnetic material layer is wound on the shielding layer.

### BACKGROUND OF THE INVENTION

This invention relates to an EMI-suppressing cable, and more particularly to an EMI-suppressing cable having a magnetic material layer formed on an outer surface of a shielding layer.

It is already known to provide a ferrite core 2 on an outer surface of a cable 1 intermediate opposite ends thereof (as shown in FIG. 4) in order to suppress the electromagnetic-wave interference (EMI). The ferrite core 2 is provided on that portion of the cable 1 disposed near to a connector 3. This portion of the cable is covered from the exterior. In this configuration, EMI noises are prevented from intruding into the cable from the exterior, and also EMI noises are prevented from radiating from a signal wire to the exterior.

However, a mounting operation for fixing the ferrite core 2 to the cable 1 is cumbersome, and also there are restrictions with respect to an increased mounting space, an increased weight, etc., so that the cost increases. And besides, there is a fear that the ferrite core 2 is damaged since it projects much from the cable 1.

In order to overcome these difficulties, there has been proposed a cable in which a second insulating layer is provided on an outer surface of a shielding layer, and an amorphous magnetic material layer is provided on an outer surface of the second insulating layer at least over a given area thereof. In this cable, a first insulating layer is provided on an outer surface of a conductor, and the shielding layer in the form of a braided metal wire is formed on an outer peripheral surface of the first insulating layer. The second insulating layer is formed on the outer surface of the shielding layer, and the amorphous magnetic material layer is formed on the outer surface of the second insulating layer over an entire length thereof or over at least part of the length thereof (see, for example, JP-A-6-203652, pages 1 to 4, FIGS. 1 and 2).

The cable, disclosed in the above patent publication, is more advantageous in the restrictions on the mounting space, the weight, etc., as compared with the cable having the ferrite core provided thereon. However, its effect of suppressing EMI noises has been low since a base tape of an amorphous magnetic tape, forming the amorphous magnetic material layer, is made of polyester or PPS.

### SUMMARY OF THE INVENTION

It is therefore an object of the present invention to provide an EMI-suppressing cable having the magnetic material layer formed on the outer surface of the shielding layer, which enable to enhance the EMI-suppressing effect and also to reduce the cost.

In order to achieve the above object, according to the present invention, there is provided EMI-suppressing cable, comprising:

a signal wire;

a shielding layer, formed on an outer surface of the signal wire; and

a magnetic material layer, formed on an outer surface of the shielding layer, and having a ferrite resin layer and a film,

wherein the ferrite resin layer is formed on one face of the film so as to form a two-layer structure; and

wherein the magnetic material layer is wound on the shielding layer.

In the above configuration, as compared with the related construction in which the ferrite core is externally provided on a localized portion of the outer surface of the cable, the externally-mounting operation is not necessary, which contributes to the reduction of the cost. And besides, there are no restriction with respect to the increased mounting space, the increased weight, etc., and therefore this cable is highly useful.

Preferably, the magnetic material layer is spirally wound around an axis of the signal wire.

Preferably, the magnetic material layer is wrapped along an axis of the signal wire.

In the above configurations, the EMI-suppressing effect can be achieved over the entire length of the cable.

Preferably, the film is comprised of metal.

In the above configuration, the film has the effect of intercepting noises as achieved by the shielding layer, and the provision of the shielding layer can be omitted, which contributes to the reduction of the cost.

Preferably, the magnetic material layer has a resin layer formed on one face of the film by printing, the resin layer containing a ferrite compound. In the above configuration, the ferrite resin layer has a higher magnetic permeability and better frequency characteristics than other magnetic material layers, the extremely-high EMI-suppressing force can be achieved.

Here, it is preferable that, the magnetic material layer has a tape shape.

Here, it is preferable that, the magnetic material layer has a single sheet shape.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a partly-broken, perspective view of an EMI-suppressing cable according to a first embodiment of the invention;

FIG. 2 an enlarged view of a portion A of FIG. 1;

FIG. 3 is a partly-broken, perspective view of an EMI-suppressing cable according to a second embodiment of the invention; and

FIG. 4 is a front-elevational view of a related cable having an externally-mounted ferrite core.

### DETAILED DESCRIPTION OF THE PREFERRED EMBODIMENTS

A first embodiment of the present invention will now be described in detail with reference to FIGS. 1 to 3. FIG. 1 shows an EMI-suppressing cable 11 in which a shielding layer 13 is formed on a signal wire 12, and a magnetic material layer 14 is formed on an outer surface of the shielding layer 13. An outer covering layer 15, called a sheath, covers an outer surface of the magnetic material layer 14.

The signal wire 12 includes a wire made of metal (such as copper and gold) having excellent electrical conductivity, and in the illustrated embodiment, the signal wire includes a bundle of conductors 12a, and each of the conductors 12a is covered with a flexible insulating material so that the short-circuiting between the adjacent conductors will not occur. However, the signal wire 12 is not limited to this type, but can include only one conductor 12a.

The shielding layer 13 includes a commonly-used braided metal wire. However, any other suitable material and structure (such as a metal foil and a metal tape) can be used for the shielding layer in so far as it is a flexible electrically conductive material.

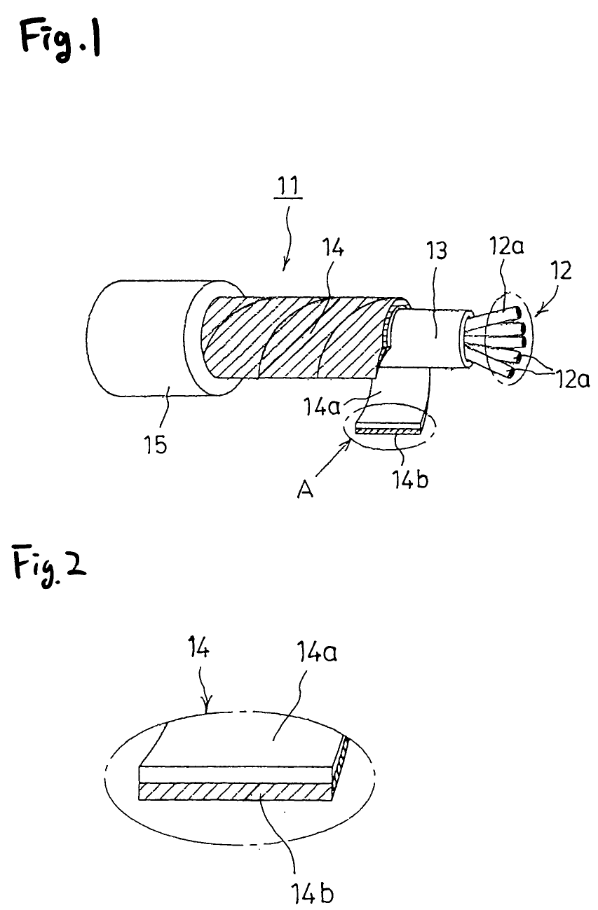

As shown in FIGS. 1 and 2, the magnetic material layer 14 includes a film 14a, and a ferrite resin layer 14b formed on one side of this film 14a, and therefore the magnetic material layer 14 has a two-layer structure. The film 14a is a base film serving to hold the ferrite resin layer 14b thereon, and this film 14a includes a flexible electrically-conductive metal film made of metal such as aluminum or copper. Unlike a film made of an insulating material such as a synthetic resin, the film 14a is made of metal, and therefore has the effect of intercepting noises as achieved by the shielding layer 13.

The ferrite resin layer 14b is formed by applying a ferrite compound-containing resin onto the one side of the film 14a by printing or the like. Because of the provision of the ferrite resin layer 14b, the magnetic material layer 14 has a higher magnetic permeability and better frequency characteristics than other magnetic material layers, and therefore exhibits an extremely-high EMI-suppressing force.

In one example shown in the drawings, the magnetic material layer 14 is spirally wound around an axis of the signal wire 12, and this magnetic material layer 14 can be formed over an entire length of the EMI-suppressing cable 11 or at least over an arbitrary length. Therefore, the cable 11 can achieve the EMI-suppressing effect over the entire length thereof as compared with the related EMI-suppressing cable in which the ferrite core is provided on a localized portion of the outer surface of the cable. And besides, the cable 11 is advantageous in the restrictions on the mounting space, the weight, etc., and the appearance of the cable will not be marred. In addition, the magnetic material layer 14 is flexible, and this magnetic material layer is covered with the outer covering layer 15, and therefore there is no fear that the magnetic material layer 14 is damaged.

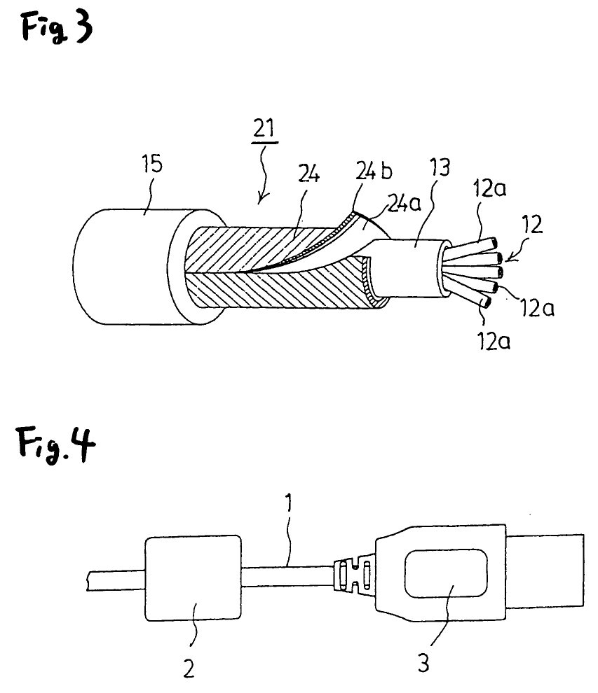

FIG. 3 shows an EMI-suppressing cable 21 according to the second embodiment of the invention. Identical constituent portions of this cable to those of the above-mentioned EMI-suppressing cable 11 will be designated by identical reference numerals, respectively, and explanation thereof will be omitted. The cable of this embodiment differs from the above EMI-suppressing cable 11 with respect to a magnetic material layer 24. This magnetic material layer 24 is totally identical to the magnetic material layer 14 of the EMI-suppressing cable 11 in that the magnetic material layer 24 has a two-layer structure, and has a ferrite resin layer 24b formed on one side of a flexible metal film 24a. However, the magnetic material layer 24 is wrapped along an axis of a signal wire 12.

In this construction, also, the ferrite resin layer 24b is formed by applying a ferrite compound-containing resin onto the one side of the film 24a by printing or the like, and this magnetic material layer 24 has a higher magnetic permeability and better frequency characteristics than other magnetic material layers, and therefore exhibits an extremely-high EMI-suppressing force.

The magnetic material layer 24 can be formed over an entire length of the EMI-suppressing cable 21 or at least over an arbitrary length. Therefore, the cable 21 can achieve the EMI-suppressing effect over the entire length thereof as compared with the conventional EMI-suppressing cable in which the ferrite core is mounted on a localized portion of the outer surface of the cable. And besides, the cable 21 is advantageous in the restrictions on the mounting space, the weight, etc., and the appearance of the cable will not be marred. In addition, the magnetic material layer 24 is flexible, and this magnetic material layer is covered with an outer covering layer 15, and therefore there is no fear that the magnetic material layer 24 is damaged.

Each of the magnetic material layers 14 and 24 has the two-layer structure, and is wound on the outer surface of the shielding layer 13, and therefore by adjusting values of the ferrite compound content, thickness, etc., of the ferrite resin layer 14b, 24b, there can be provided the EMI-suppressing cable which is more inexpensive, and achieves the more effective EMI-suppressing effect than the conventional cables. And besides, the magnetic material layer 14, 24 includes the metal film 14a, 24a, and this film 14a, 24a itself has a noise-intercepting effect, and therefore the provision of the shielding layer 13 can be omitted.

The EMI-suppressing cables 11 and 12 can be used, for example, as a cable for connecting a computer game machine body and a game controller together, and can also be used as a connecting cable for personal computer-associated parts and in home electric appliances and others. In such a case, also, the use of an externally-mounted ferrite core is not necessary, and the use of electronic parts within the controller and the use of an EMI prevention part are not necessary, and therefore these contribute to the reduction of the cost. And besides, if the shielding layer within the cable is saved, the cost can be further reduced.

In the present invention, various modifications can be made without departing from the spirits of the invention, and such modifications fall within the scope of the invention.

What is claimed is:

1. An EMI-suppressing cable, comprising:
a signal wire;
a shielding layer, formed on an outer surface of the signal wire; and
a magnetic material layer, formed on an outer surface of the shielding layer, and having a ferrite resin layer and a film,
wherein the ferrite resin layer is formed on one face of the film so as to form a two-layer structure; and
wherein the magnetic material layer is wound on the shielding layer.

2. The EMI-suppressing cable as set forth in claim 1, wherein the magnetic material layer is spirally wound around an axis of the signal wire.

3. The EMI-suppressing cable as set forth in claim 1, wherein the magnetic material layer is wrapped along an axis of the signal wire.

4. The EMI-suppressing cable as set forth in claim 1, wherein the film is comprised of metal.

5. The EMI-suppressing cable as set forth in claim 1, wherein the magnetic material layer has a resin layer formed on one face of the film by printing, the resin layer containing a ferrite compound.

6. The EMI-suppressing cable as set forth in claim 2, wherein the magnetic material layer has a tape shape.

7. The EMI-suppressing cable as set forth in claim 3, wherein the magnetic material layer has a single sheet shape.
